(19) United States
(12) Patent Application Publication
(10) Pub. No.: US 2026/0342429 A1
(43) Pub. Date: Oct. 29, 2026

(54) NETWORK-CONTROLLED REPEATER BEAM CAPABILITIES REPORT FOR ACCESS LINK

(71) Applicant: Lenovo (Singapore) Pte. Ltd., Singapore (SG)

(72) Inventors: ALI RAMADAN ALI, Kraiburg am Inn (DE); Majid Ghanbarinejad, Chicago, IL (US); Karthikeyan Ganesan, Nauheim (DE)

(21) Appl. No.: 19/114,424

(22) PCT Filed: Sep. 26, 2023
(86) PCT No.: PCT/IB2023/059548

§ 371 Date: Mar. 21, 2025

Related U.S. Application Data
(60) Provisional application No. 63/377,525, filed on Sep. 28, 2022.

(51) Int. Cl. H04B 7/155; H04W 28/02

(52) U.S. Cl. CPC H04B 7/15528; H04W 28/0215

(57) ABSTRACT

Various aspects of the present disclosure relate to devices and methods for a network-controlled repeater (NCR) device to be efficiently configured by a base station. The NCR device communicates with: (i) at least one base station of a network via (a) a first link or (b) a second link; and (ii) a user equipment via a third link. The NCR device receives, from the at least one base station, one or more control messages including a configuration for sending repeater capability information of the third link. In response to receiving the configuration, the NCR device determines the repeater capability information and transmits, via the at least one transceiver, the repeater capability information to the at least one base station, enabling efficient beam indications by the at least one base station.

### PRIORITY APPLICATION

The application claims priority to U.S. Provisional Application No. 63/377,525 filed Sep. 28, 2022, the content of which is fully incorporated herein.

### TECHNICAL FIELD

The present disclosure relates to wireless communications, and more specifically to network control of a repeater that extends a coverage area for wireless communication.

### BACKGROUND

A wireless communications system may include one or multiple network communication devices, including base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G (e.g., sixth generation (6G)).

Coverage is a fundamental aspect of cellular network deployments. Mobile operators rely on different types of network nodes to offer blanket coverage in their deployments. Deployment of regular full-stack cells is one option but may not be always technically possible or economically viable. As a result, new types of network nodes have been considered to increase mobile operators' flexibility for their network deployments. For example, Integrated Access and Backhaul (IAB) is a new type of network node not requiring a wired backhaul. Another type of network node is a radio frequency (RF) repeater that simply amplifies-and-forwards any signal that the RF repeater receives. RF repeaters have seen a wide range of deployments in 2G, 3G and 4G to supplement the coverage provided by regular full-stack cells. The 5G New Radio (NR) radio access technologies (RATs) have RF and Electromagnetic Compatibility (EMC) requirements for such RF repeaters for NR targeting both Frequency Range 1 (FR1) and Frequency Range 2 (FR2).

### SUMMARY

The present disclosure relates to methods, apparatuses, and systems that provide procedures and signaling for a network-controlled repeater (NCR) device to efficiently communicate with user devices via an access link. According to one or more aspects of the present disclosure, a solution is advanced for capability reporting, by the NCR device to a network device, of an NCR-forward section of the NCR device that supports repeating of: (i) a downlink on backhaul link from the network device to a user device via an access link; and (ii) an uplink on an access link from the user device to the network device via a backhaul link. The capability report includes details of supported beams and their characteristics. The capability report may include: (i) maximum number of transmit (Tx) and receive (Rx) beams in the access link; (ii) beam widths to distinguish between the supported wide and narrow beams; (iii) a list of narrow beams within wide beams for efficient beam refinement in the access link; and (iv) detailed capability information per gNB request in a physical (PHY) layer (“L1”).

Some implementations of the method and apparatuses described herein may include a method for wireless communication at a repeater device. In one or more embodiments, the method includes communicating, via at least one transceiver of a repeater device: (i) with at least one network device of a network via (a) a first link or (b) a second link; and (ii) with a user device via a third link. The method includes receiving, from the at least one network device via the at least one transceiver, one or more control messages that includes a configuration for sending repeater capability information of the third link. In response to receiving the configuration, the method includes determining the repeater capability information and transmitting, via the at least one transceiver, the repeater capability information to the network device.

Some implementations of the method and apparatuses described herein may include a method for wireless communication at a network device. In one or more embodiments, the method includes communicating, via at least one transceiver of the network device: (i) with a repeater device via a first link; and (ii) indirectly with a user device via a second link to the repeater device, the repeater device configured to repeat communication via a third link with the user device. The method includes transmitting, via the at least one transceiver to the repeater device, one or more control messages including a configuration for sending repeater capability information of the third link, the control messages prompting the repeater device to determine the repeater capability information. The method includes receiving, via the at least one transceiver, the repeater capability information.

### BRIEF DESCRIPTION OF THE DRAWINGS

FIG. 1 is an example of a wireless communications system enabling repeating of wireless communication by a network-controller repeater (NCR) device, in accordance with aspects of the present disclosure.

FIG. 2 is a portion of the wireless communications system including a network device, the NCR device, and a user equipment (UE) that is outside of a coverage area for the network device, in accordance with aspects of the present disclosure;

FIG. 3 is the wireless communications system with the NCR device reporting, to the network device, a capability of supported narrow and wide beams in an access link, in accordance with aspects of the present disclosure.

FIGS. 4A-4L are example abstract syntax notation one (ASN.1) code for implementing NCR-MT capability reporting, in accordance with aspects of the present disclosure.

FIG. 5 illustrates a block diagram of a device that performs or remotely configures repeating of wireless communication, in accordance with aspects of the present disclosure.

FIG. 6 illustrates a flowchart of a method performed by a repeater device that reports, to a network device, capabilities of repeating communication on an access link with a UE, in accordance with aspects of the present disclosure.

FIG. 7 illustrates a flowchart of a method performed by a network device that configures a repeater device to report, to the network device, capabilities of repeating communication on an access link with a UE, in accordance with aspects of the present disclosure.

### DETAILED DESCRIPTION

While a conventional RF repeater presents a cost-effective means of extending network coverage to a communications system, the RF repeater has its limitations. An RF repeater simply does an amplify-and-forward operation without being able to consider various factors that could improve performance. Such factors may include information on semi-static and/or dynamic downlink/uplink configuration, adaptive transmitter/receiver spatial beamforming, ON-OFF status, etc.

A network-controlled repeater (NCR) device provides an enhancement over conventional RF repeaters by integrating the capability to receive and process side control information from the network. An NCR device contains two main components/functions, the NCR mobile terminal (NCR-MT) responsible for receiving the side control information via a control link (C-Link) and the NCR forward components (NCR-Fwd) that is responsible for amplifying and forwarding uplink/downlink (UL/DL) physical (PHY) channels/signals for both backhaul and access links. Side control information could allow the NCR device to perform the amplify-and-forward operation in a more efficient manner. Potential benefits could include mitigation of unnecessary noise amplification, transmissions and receptions with better spatial directivity, and simplified network integration. The NCR device presents issues with implementing the additional functionality enabled by side control information.

The network device indicates beam information of the access link, a beam index, and a corresponding time domain resource, to apply the beam to the NCR device via the C-link instead of using the legacy reference signal resource identifier (ID)-based beam indication. In order to support the new signaling of beam IDs and the corresponding time domain resources, the network device, such as a gNB, needs to perform association between the beams/beam IDs of NCR-FWD for the access link and the indicated beams to the UE, based on reference signal (RS) resources. To efficiently perform this feature, the gNB requires information about the supported physical beams at the repeater for the access link.

According to one or more aspects of the present disclosure, a solution is advanced for capability reporting, by the NCR device to the network device, of the NCR-FWD that includes details of the supported beams and their characteristics. In particular, a new capability report for NCR access link is introduced. The capability report may include: (i) maximum number of transmit (Tx) and receive (Rx) beams in the access link; (ii) beam widths to distinguish between the supported wide and narrow beams; (iii) a list of narrow beams within wide beams for efficient beam refinement in the access link; and (iv) detailed capability information per gNB request in a physical (PHY) layer (“L1”).

In one aspect of the present disclosure, a method is provided at a network-controlled repeater (NCR) device, where the method includes receiving a configuration for sending repeater capability information of the access link. The method includes transmitting capability information to the gNB. The method includes receiving a request from the gNB for sending specific capability information to the gNB. In one or more embodiments, the configuration includes a list of capability information to be sent to the network during the attach procedure of the NCR-MT. In one or more embodiments, the configuration includes a predefined table of the fine details of each capability information. In one or more embodiments, the NCR device sends as part of its capability information, information of the supported beams for the forward access link between the NCR device and the UE. In one or more embodiments, a new Information Element (IE) beam-ParametersPerBand-NCR-FWD is introduced into the UE capability that carries the beam capability information.

In one or more embodiments, the UE capabilities of supported beams include beam parameters per band information that contains information about the maximum supported beams for DL transmission and for UL reception of access link per supported band. In one or more embodiments, the beam parameters per band information contains information about the beam widths of the supported beams per supported band. In one or more embodiments, the beam parameters per band information contains information about the list of narrow beams within each wide beam. In one or more embodiments, the beam parameters per band information contains information about the number of supported antenna panels. In one or more embodiments, the beam parameters per band information contains information about the angles for each reported beam related to the antenna panel boresight. In one or more embodiments, the beam parameters per band information contains information about the maximum allowed transmission power per beam for interference management. In one or more embodiments, the NCR device sends the capability report during an attach procedure in an NCR-MT specific message. In one or more embodiments, a connected NCR device receives a request from the network device such as a base station for sending details for specific capability information. In one or more particular embodiments, the request is an RRC dedicated message. In one or more particular embodiments, the request is received by the NCR device in L1 as a field in NCR-MT downlink control information (DCI) that carries side control information. In one or more particular embodiments, the request is an index of a predefined table that stores the detailed capability information. In one or more embodiments, the NCR device sends the detailed capability information in response to the request in uplink control information (UCI) over Physical Uplink Control Channel (PUCCH)/Physical Uplink Shared Channel (PUSCH).

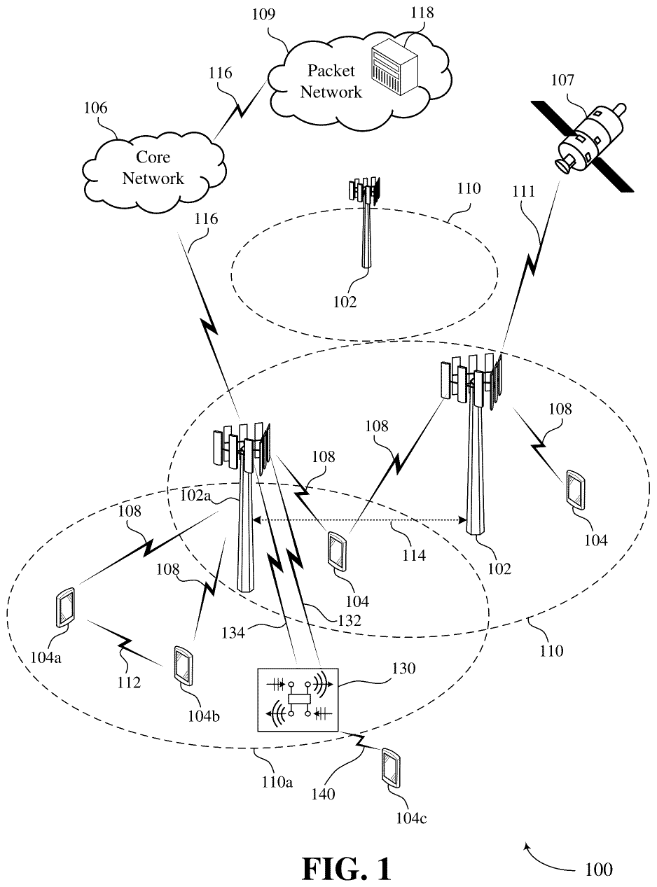

FIG. 1 illustrates an example of a wireless communications system 100 enabling repeating of wireless communication by a network-controller repeater (NCR) device, in accordance with aspects of the present disclosure. The wireless communications system 100 may include one or more network devices 102, one or more UEs 104, a core network 106, and a packet data network 109. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G, or other suitable radio access technology including Institute of Electrical and Electronics Engineers (IEEE) 802.11 (Wi-Fi), IEEE 802.16 (WiMAX), IEEE 802.20. Additionally, the wireless communications system 100 may support technologies, such as time division multiple access (TDMA), frequency division multiple access (FDMA), or code division multiple access (CDMA), etc.

The one or more network devices 102 may be dispersed throughout a geographic region to form the wireless communications system 100. One or more of the network devices 102 described herein may be, may include, or may be referred to as a network node, a base station, a network element, a radio access network (RAN), a base transceiver station, an access point, a NodeB, an eNodeB (eNB), a next-generation NodeB (gNB), a network device, or other suitable terminology. A network device 102 and a UE 104 may communicate via a communication link 108, which may be a wireless or wired connection. For example, a network device 102 and a UE 104 may wirelessly communicate (e.g., receive signaling, transmit signaling) over a user to user (Uu) interface.

A network device 102 may provide a geographic coverage area 110 for which the network device 102 may support services (e.g., voice, video, packet data, messaging, broadcast, etc.) for one or more UEs 104 within the geographic coverage area 110. For example, a network device 102 and a UE 104 may support wireless communication of signals related to services (e.g., voice, video, packet data, messaging, broadcast, etc.) according to one or multiple radio access technologies. In some implementations, a network device 102 may be moveable, for example, a satellite 107 associated with a non-terrestrial network and communicating via a satellite link 111. In some implementations, different geographic coverage areas 110 associated with the same or different radio access technologies may overlap, but the different geographic coverage areas 110 may be associated with different network devices 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network devices 102, other UEs 104, or network equipment (e.g., the core network 106, the packet data network 109, a relay device, an integrated access and backhaul (IAB) node, or another network equipment), as shown in FIG. 1. Additionally, or alternatively, a UE 104 may support communication with other network devices 102 or UEs 104, which may act as relays in the wireless communications system 100.

A UE 104a may also be able to support wireless communication directly with other UEs 104b over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104a may support wireless communication directly with another UE 104b over a PC5 interface. PC5 refers to a reference point where the UE 104a directly communicates with another UE 104b over a direct channel without requiring communication with the network device 102a.

A network device 102 may support communications with the core network 106, or with another network device 102, or both. For example, a network device 102 may interface with the core network 106 through one or more backhaul links 114 (e.g., via an S1, N2, or another network interface). The network devices 102 may communicate with each other over the backhaul links 114 (e.g., via an X2, Xn, or another network interface). In some implementations, the network devices 102 may communicate with each other directly (e.g., between the network devices 102). In some other implementations, the network devices 102 may communicate with each other indirectly (e.g., via the core network 106). In some implementations, one or more network devices 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission and reception points (TRPs).

In some implementations, a network entity or network device 102 may be configured in a disaggregated architecture, which may be configured to utilize a protocol stack physically or logically distributed among two or more network entities or network devices 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity or network device 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission and reception point (TRP). One or more components of the network entities or network devices 102 in a disaggregated RAN architecture may be co-located, or one or more components of the network entities or network devices 102 may be located in distributed locations (e.g., separate physical locations). In some implementations, one or more network entities or network devices 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities or network devices 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more network devices 102 associated with the core network 106.

The core network 106 may communicate with the packet data network 109 over one or more backhaul links 116 (e.g., via an S1, N2, N2, or another network interface). The packet data network 109 may include an application server 118. In some implementations, one or more UEs 104 may communicate with the application server 118. A UE 104 may establish a session (e.g., a protocol data unit (PDU) session, or the like) with the core network 106 via a network entity or network device 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities or network devices 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities or network devices 102 and the UEs 104 may support different resource structures. For example, the network entities or network devices 102 and the UEs 104 may support different frame structures. In some implementations, such as in 4G, the network entities or network devices 102 and the UEs 104 may support a single frame structure. In some other implementations, such as in 5G and among other suitable radio access technologies, the network entities or network devices or network devices 102 and the UEs 104 may support various frame structures (i.e., multiple frame structures). The network entities or network devices 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHZ), and FR5 (114.25 GHZ-300 GHz). In some implementations, the network entities or network devices 102 and the UEs 104 may perform wireless communications over one or more of the operating frequency bands. In some implementations, FR1 may be used by the network entities or network devices 102 and the UEs 104, among other equipment or devices for cellular communications traffic (e.g., control information, data). In some implementations, FR2 may be used by the network entities or network devices 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Network-controlled repeater (NCR) devices 130 may enable network device 102a to communicate with UE 104c that is outside of coverage area 110a. Network device 102a communicates via control link 132 and backhaul link 134 with NCR device 130. NCR device 130 communicates on access link 140 with UE 104c. NCR device 130 efficiently extends the network coverage in both uplink and downlink with the help of side control information from the network. This information may include time division duplex (TDD) switching, timing information, power control, as well as common and UE dedicated spatial information for beamforming.

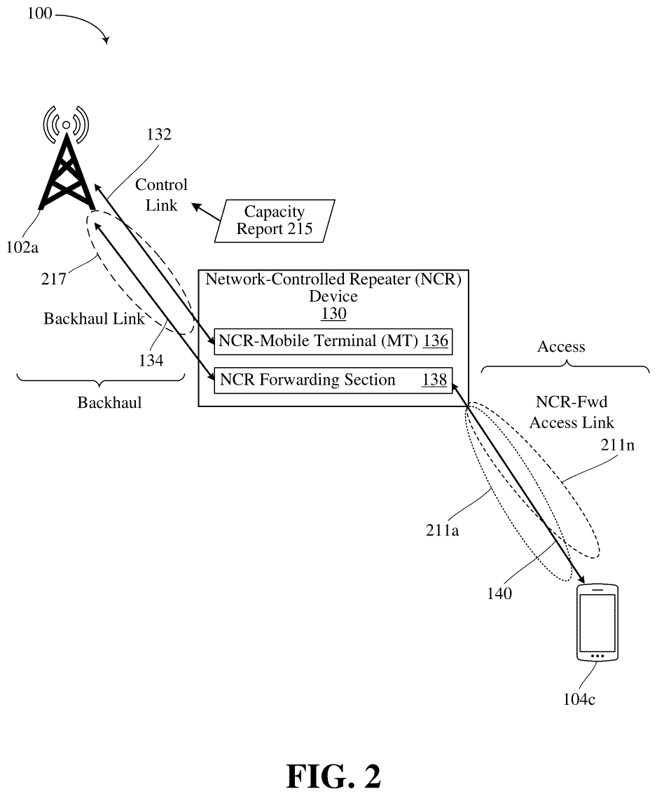

FIG. 2 illustrates a portion of the wireless communications system 100 including the network device 102a, a UE 104c that is outside of a coverage area 110a (FIG. 1) for the network device 102a, and an intervening NCR device 130 that receives and transmits (i.e., repeats) communication between network device 102a and UE 104c. Wireless communications system 100 may extend a coverage area 110a for the network device 102a by including an NCR device 130 that is able to reach a UE 104c. NCR device 130 communicates with the network device 102a via both a side control link 132, which may be referred to as a “C-link”, and via a backhaul link 134. The side control link 132 terminates at the NCR device 130, which accordingly acts as an NCR mobile terminal (NCR-MT) 136. The NCR device 130 includes an NCR forwarding section 138 that receives and amplifies a DL radio frequency (RF) signal received via the backhaul link 134 and forwards the DL RF signal with minimal delay via an access link 140 to the UE 104c. Similarly, the NCR forwarding section 138 receives and amplifies an UL RF signal received via the access link 140 and forwards the UL RF signal with minimal delay via the backhaul link to the network device 102a. The network device 102a is able to configure the NCR forwarding section 138 via configuration information sent via the side control link 132 to the NCR-MT 136. NCR device 102a has capabilities such as supported beams 211a through 211n for supporting NCR-Fwd access link 140 for UE 104c. NCR device 102 communicates capacity report 215 via backhaul beam(s) 217 on control link 132 to network device 102a.

Aspects of the present disclosure may apply more generally to communication links referred to with different labels. In one or more embodiments, the control link 132 may generally be a first link, the backhaul link 134 may generally be a second link, and the access link 140 may generally be a third link.

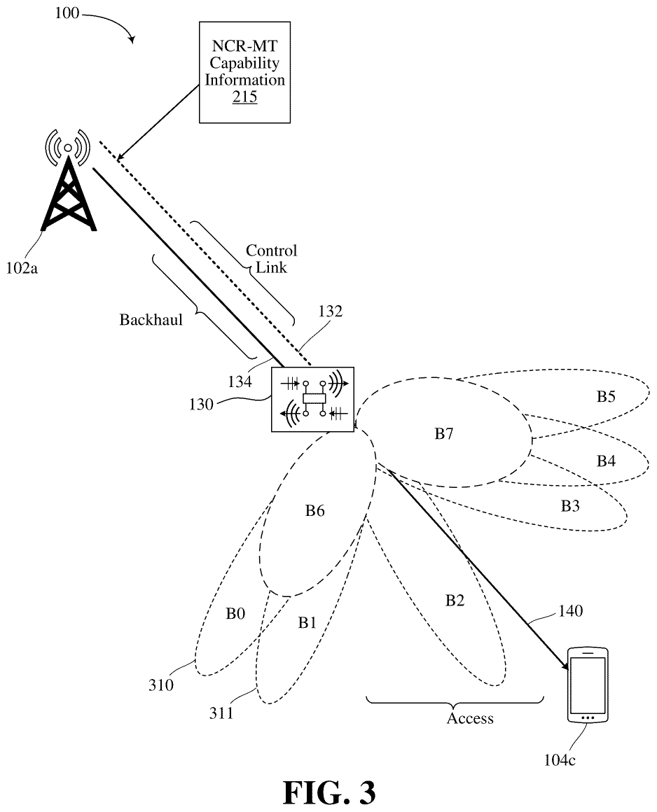

FIG. 3 is an example of NCR device 130 of communication system 100 of FIG. 1 reporting NCR-MT capability report 215 indicating supported narrow beams (B0-B5) 310, 311, 312, 313, 314, and 315 and indicating wide beams (B6-B7) 316-317 in access link 140. In particular, NCR device 130 may further indicate that the narrow beams (B0-B1) 310-311 are associated with (e.g., angularly significantly within) wide beam (B6) 316 and the narrow beams (B3-B5) are associated with (e.g., angularly significantly within) wide beam (B7) 317. This information is useful for network device 102a, for data transmission, to indicate to NCR device 130 the narrow beams (e.g., for Channel State Information Reference Signal (CSI-RS) transmission or data transmission) within the suitable Synchronization Signal Block (SSB) beam that has been indicated by the UE during initial access which can be indicated to Channel State Information Reference Signal for beam refinement within the detected SSB beam. In yet another implementation, beam parameters may be included. In an example, the beam parameters may include a list of the angles of the supported beams, in respect to the boresight of the antenna array. In another example, the beam parameters may include the allowed Tx power for each beam. The beams may be configured by OAM-based control, by hard coded control, or by network control for better interference management.

In one embodiment, the present disclosure provides for beam capabilities information exchange for access link during attach procedure of NCR-MT as part of UE reporting other capabilities. According to the embodiment, NCR-MT 136 (FIG. 2) is (pre-)configured to report its capabilities of the access link to the gNB, whereby the capability is sent by the NCR-MT in the UL during attach (connection) procedure to the network. The gNB, based on the reported repeater capability of the supported analog beams for the access link, performs mapping/association of the beams indicated to the UEs and the beams reported by the repeater for the access link. The reported repeater capability includes the beam capability information needed at the gNB for beam ID indication to the repeater for beamforming the signal transmitted/received to/from the UE in the access link. In one implementation, the capability information may contain the maximum number of supported DL transmission and the UL reception beams since, for beam indication, separate beam IDs and the corresponding time slots need to be indicated to the repeater during PHY channels forwarding, according to the TDD configuration. The beam information capability can be introduced as an IE into the RF-Parameters of the UE-NR-Capability information that is transmitted from the NCR device to the network in messages or information elements (IEs).

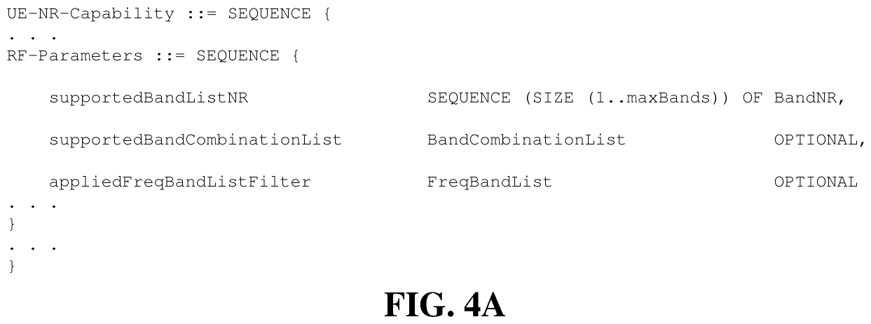

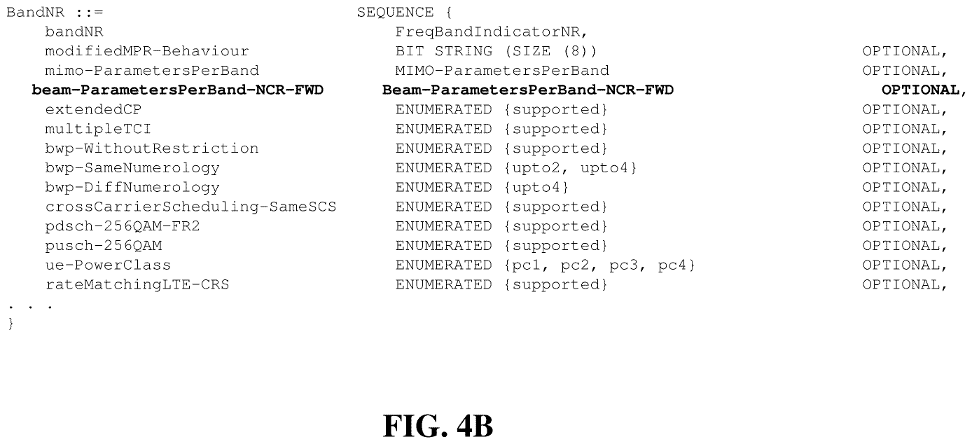

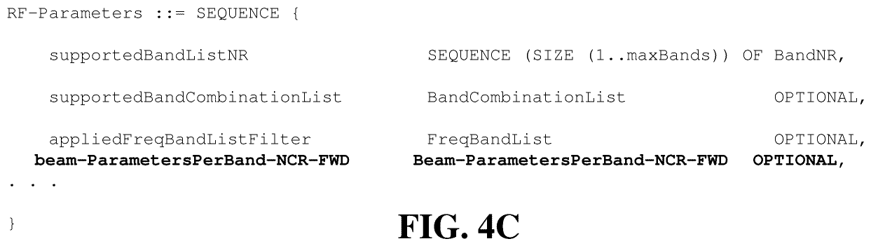

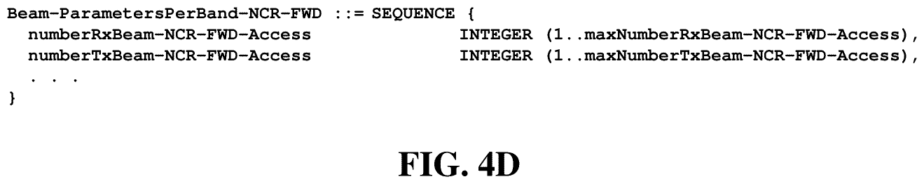

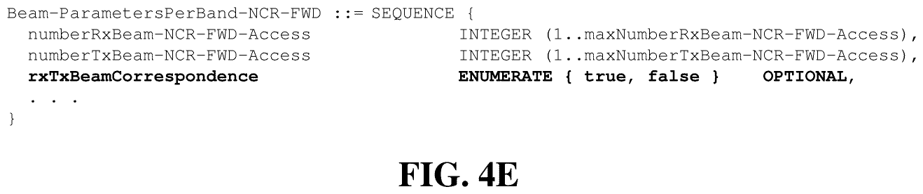

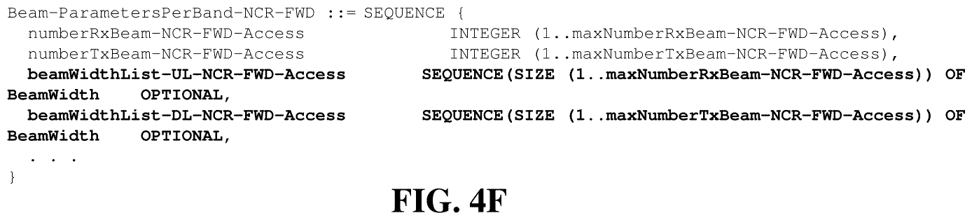

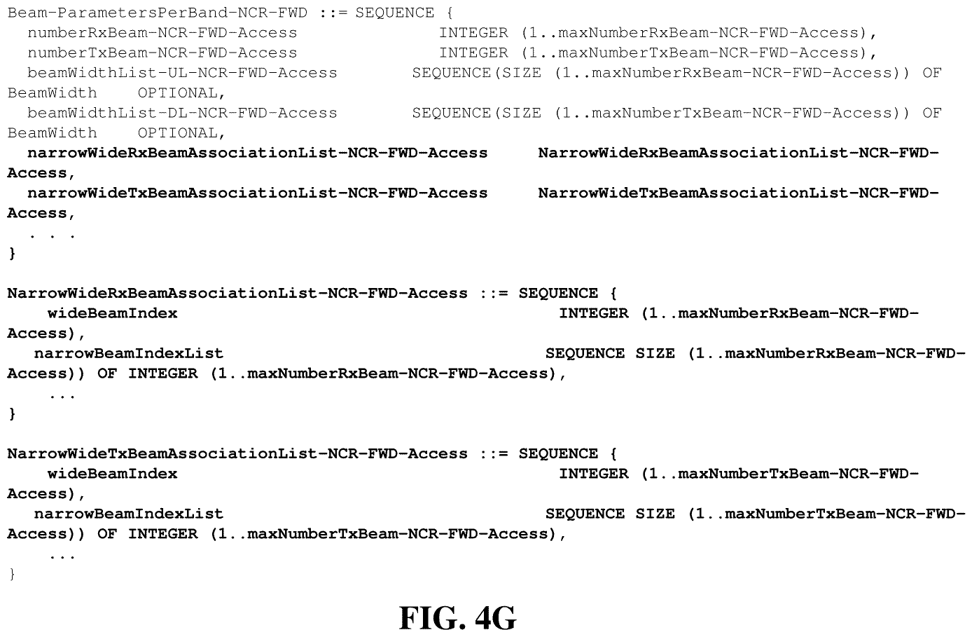

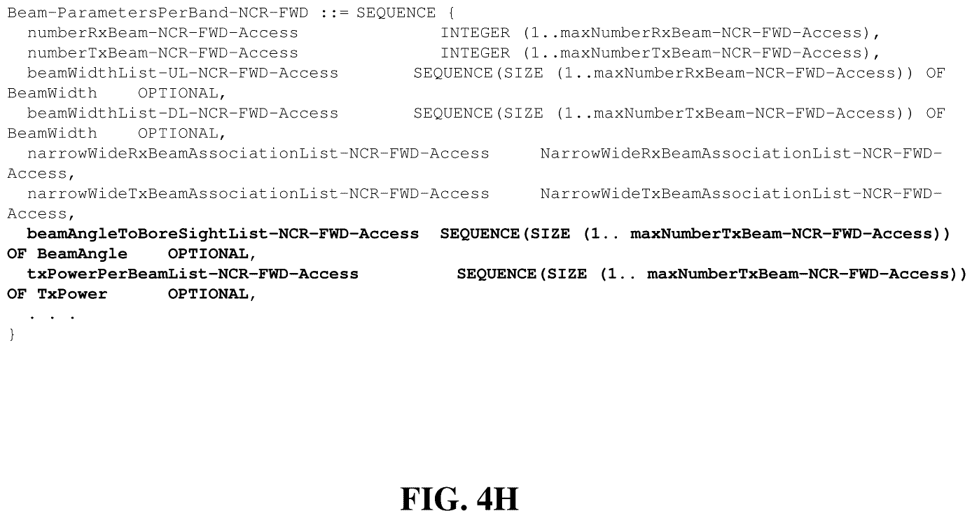

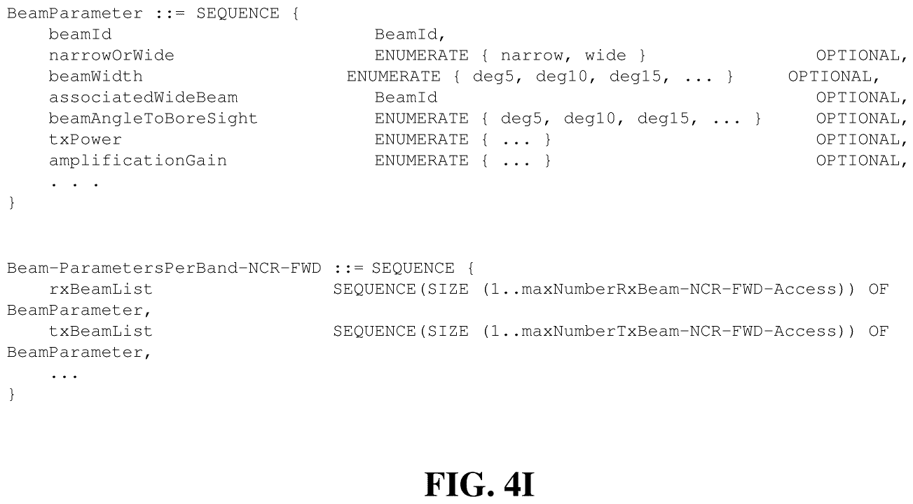

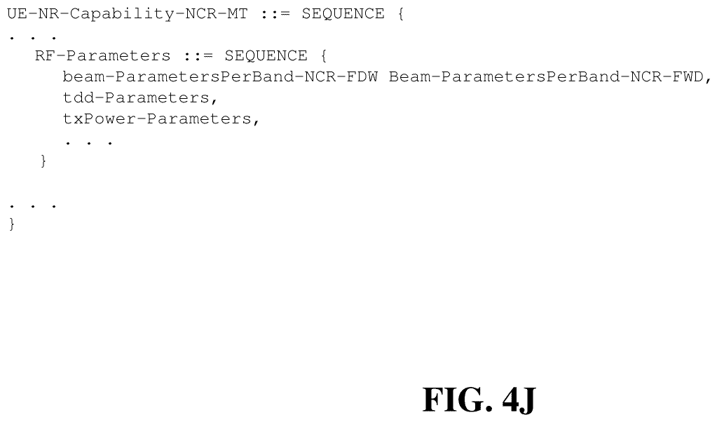

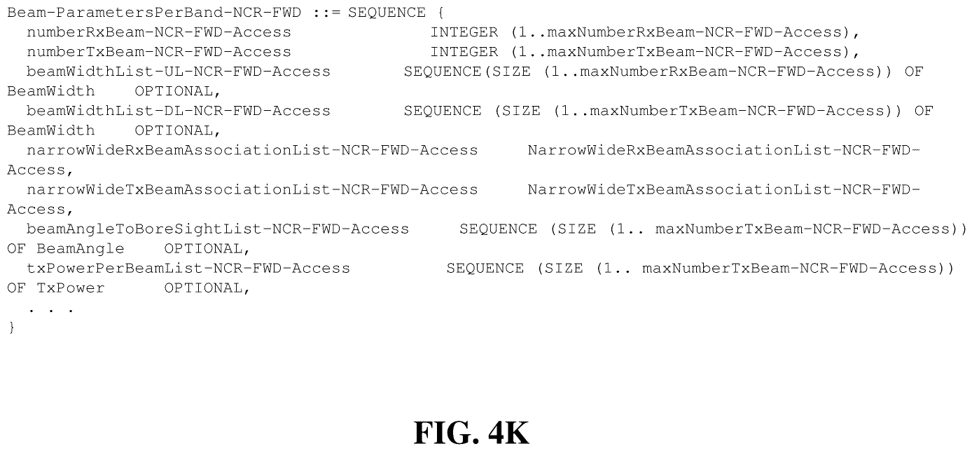

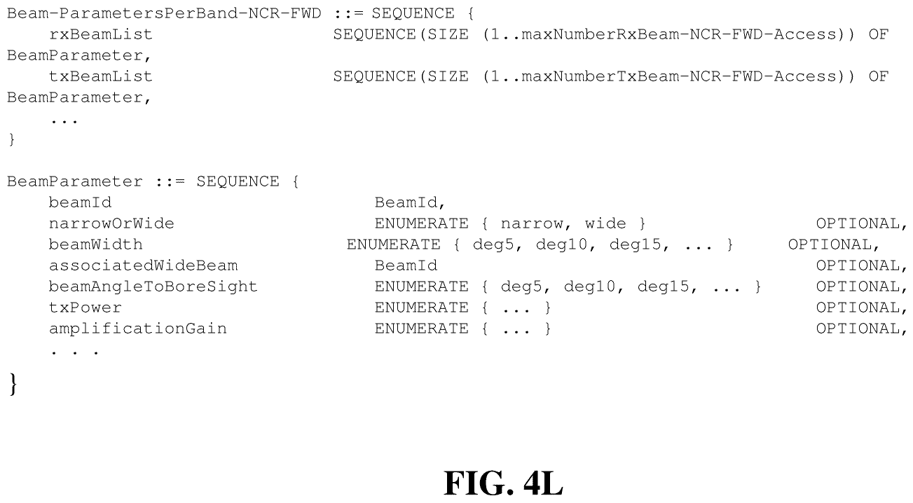

Since the number of supported UL and DL beams of the repeater access-link depends on the frequency band (i.e., more beams can be supported for high frequency bands than the lower frequency bands), the beam capability information is sent per band as part of bandNR IE. FIG. 4A is an example abstract syntax notation one (ASN.1) code for bandNR IE that includes beam capability information per band, with ellipsis ( . . . ) representing potentially omitted code.

In various embodiments, a new IE Beam-ParametersPerBand-NCR-FWD is introduced to carry the beam capability information of the NCR for the forward access link per band. FIG. 4B is an example ASN.1 code for a Beam-ParametersPerBand-NCR-FWD IE with bold-faced font annotating introduced new features.

As an alternative, Beam-ParametersPerBand-NCR-FWD may be comprised by a different IE or sent in a separate capability message. An example is sending Beam-ParametersPerBand-NCR-FWD in the RF-Parameters message. FIG. 4C is an example ASN.1 code for sending Beam-ParametersPerBand-NCR-FWD in the RF-Parameters message with bold-faced font being code proposed herein.

In one implementation, the maximum number of supported beams for transmission in the DL access link and the maximum number of supported beams for the reception in the UL access link for a particular band are sent in the beam parameter information to the gNB. FIG. 4D is an example ASN.1 code for sending maximum numbers of supported beams UL/DL of access link in particular bands, with bold-faced font being code proposed herein.

In one example, if the two parameters numberRxBeam-NCR-FWD-Access and numberRxBeam-NCR-FWD-Access are equal, the gNB may assume beam correspondence (channel reciprocity) between Rx and Tx beams, i.e., Rx beam 0 corresponds to Tx beam 0, Rx beam 1 corresponds to Tx beam 1, and so on. In another example, a parameter indicating beam correspondence may be optionally included when the two parameters are equal. FIG. 4E is an example ASN.1 code for sending maximum numbers of supported beams UL/DL of access link in particular bands with an indication when equal with bold-faced font being code proposed herein.

In another implementation, the beam parameter information includes, in addition to the maximum number of supported beams, the 3 dB beam width for each supported beam. This is useful for the gNB to identify (i) relatively wide beams whose IDs can be indicated to the repeater for forwarding broadcast channels such as Synchronization Signal Block (SSB), Physical Random Access Channel (PRACH), common Downlink Control Information (DCI), etc., and (ii) relatively narrow beams whose IDs can be indicated to the repeater for forwarding PHY channels, e.g., for shared channels and other UE dedicated data communication. In one implementation, a beam width for each reported beam is reported to the gNB. In another implementation, if multiple beams have similar/comparable beam widths, a single beam width is sent associated with multiple beams. FIG. 4F is an example ASN.1 code for sending narrow/wide beam information ‘with bold-faced font being code proposed herein.

In yet another implementation, the beam parameter information includes information of association among narrow beams and wide beams, such as described above with regard to FIG. 3. The information may indicate, for example, which narrow beams are angularly significantly within which wide beams. This is useful for the gNB to identify (i) the wide beams whose IDs can be indicated to the repeater for forwarding broadcast channels such as SSB, PRACH, common DCI, etc., and (ii) narrow beams whose IDs can be indicated to the repeater for forwarding PHY channels with narrow beams, e.g., for UE dedicated data transmission. FIG. 4G is an example ASN.1 code for sending beam association information for narrow and wide beams with bold-faced font being code proposed herein.

In yet another implementation, beam parameters such as list of the angles of the supported beams in respect to the boresight of the antenna array and the allowed Tx power for each beam that may be configured with OAM-based/hard coded or controlled by the network for better interference management. FIG. 4H is an example ASN.1 code for sending beam angle information with bold-faced font being code proposed herein.

An alternative realization is to communicate any or all such beam information in a list of parameters, each parameter comprising any or all the information for a corresponding beam. FIG. 4I is an example ASN.1 code for sending all beam information in a list of parameters with bold-faced font being code proposed herein.

The repeater may indicate further to the network its capability to support multiple simultaneous beams for transmission and/or reception and/or information of association between Rx/Tx beams and antenna panels. Such association may imply that Rx/Tx beams associated with one antenna panel may not be applied simultaneously, but Rx/Tx beams associated with multiple antenna panels may be applied simultaneously. The antenna panel may refer to a physical antenna panel or otherwise an antenna apparatus that can apply one Rx and/or Tx beam at a time.

Furthermore, if the NCR supports full-duplex RF/antennas, the information of the capability may be signaled to the gNB. The information indicates to the gNB whether an Rx beam and a Tx beam may be applied by the antenna panel simultaneously.

Yet furthermore, other information related to antenna panels and/or beams, e.g., number of horizontal and/or vertical antenna elements, antenna element on/off capabilities, etc., may also be communicated to the gNB, as the information may help the gNB with scheduling, anticipating expected cross-link interference, and so on.

In a second embodiment, aspects of the present disclosure provide, as NCR-MT specific capability, capabilities information exchange for access link during attach procedure of NCR-MT. According to this embodiment, NCR-MT is (pre-)configured to report its capabilities of the access link to the gNB, where the capability is sent by the NCR-MT in the UL during the attach (connection) procedure to the network. Based on the reported repeater capability of the supported analog beams for the access link, the gNB performs mapping/association of the beams indicated to the UEs and the beams reported by the repeater for the access link. The reported repeater capability includes the beam capability information needed at the gNB for beam ID indication to the repeater for beamforming the signal transmitted/received to/from the UE in the access link. In one implementation, the capability information may contain the maximum number of supported DL transmission and the UL reception beams since, for beam indication, separate beam IDs and the corresponding time slots need to be indicated to the repeater during PHY channels forwarding, according to the TDD configuration. The beam information capability can be introduced as new message UE-NR-Capability-NCR-MT, which is specific for the UE type of NCR-MT that is identified during the attach procedure of the repeater to the network. This message can be used to carry all related capability information of the NCR, including the NCR-MT capability and NCR-FWD capability, including both backhaul link and access link.

For access link, since the number of supported UL and DL beams of the repeater access-link depends on the frequency band (i.e., more beams can be supported for high frequency bands than the lower frequency bands), the beam capability information is sent per band as part of bandNR IE. FIG. 4J is an example ASN.1 code for sending beam capability information per band with bold-faced font being code proposed herein.

The IE beam-ParametersPerBand-NCR-FWD is introduced to carry the beam capability information of the NCR for the forward access link per band. FIG. 4K is an example ASN.1 code for sending beam capability information per band via IE beam-ParametersPerBand-NCR-FWD with bold-faced font being code proposed herein.

An alternative realization is to communicate any or all such beam information in a list of parameters, each parameter comprising any, or all of, the information for a corresponding beam. FIG. 4L is an example ASN.1 code for sending all beam information in a list of parameters with bold-faced font being code proposed herein.

According to a third embodiment, the present disclosure provides capabilities information for access link per gNB request. According to this embodiment, NCR-MT is (pre-)configured to report its capabilities of the access link to the gNB, where part of the capability is sent by the NCR-MT in the UL during attach (connection) procedure to the network. The part of the capability that is sent may contain the high-level capability information. The other part of the capability is sent using UL PUCCH or PUSCH of the NCR-MT based on gNB request as an enquiry for certain capability details. Upon receiving the high-level capability information of the access link from the NCR-MT, the gNB may request specific details of one or more of the reported capabilities. The request may be sent to the NCR-MT as part of the RRC dedicated messages or inserted in the repeater specific DCI that carries the side control information to the repeater. The reported repeater capability per gNB request includes the beam capability information details needed at the gNB for beam ID indication to the repeater for beamforming the signal transmitted/received to/from the UE in the access link.

In one implementation, the gNB sends a request to the repeater for the specific details of capability. In another implementation, the gNB sends a row index of a predefined table at the repeater where details of each capability are stored. Based on the reported high-level repeater capability, e.g., based on the list of the supported beams by the repeater, the gNB may request specific details of the capability after the connection. For example, the gNB may request the list of the narrow beams that can be used for beam refinement and/or the list of the narrow beams within a specific wide beam. The indicated wide beam can be the beam that was used for UE initial access (associated with the detected SSB beam by the UE), so that the gNB performs beam refinement within that wide beam. The gNB may request details of the angles as reference to the antenna boresight of specific beams or the allowed Tx power of list of beams for interference management. The gNB may request the supported simultaneous beam transmission and/or the supported antenna panels.

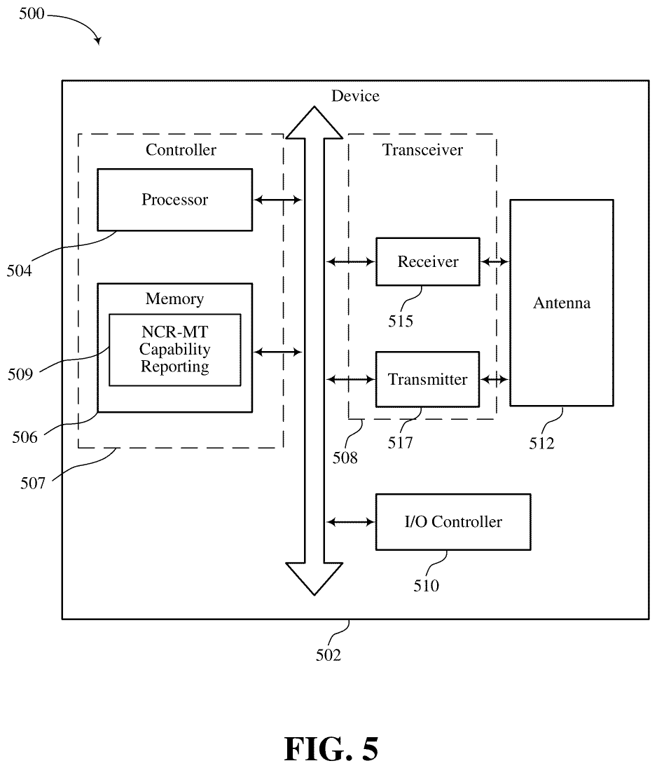

FIG. 5 illustrates an example of a block diagram 500 of a device 502 that supports beam indication for an NCR device, in accordance with aspects of the present disclosure. The device 502 may be an example of a network entity or network device 102 or a UE 104 (FIG. 1) as described herein. The device 502 may support wireless communication with one or more network entities or network devices 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. A controller 507, which includes the processor 504, configures the device 502 to perform the functionality of the present disclosure. The controller 507 can include or can be communicatively coupled to the memory 506 to execute program code. Controller 507 may include dedicated memory solely accessible by the processor 504 and which is a portion of memory 506. In some implementations, the processor 504 and the memory 506 coupled with the processor 504 may be configured to perform one or more of the functions operating collectively as a controller 507 described herein (e.g., executing, by the processor 504, instructions stored in the memory 506). In an example, the processor 504 of a device controller 507 executes an NCR-MT capability reporting application 509 to convey beam capabilities of the NCR device capabilities from the NCR-MT 136 (FIG. 2) to the network device 102a (FIG. 2) in determining a beam indication for configuring a transceiver 508 of the device 502 to perform NCR forwarding.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device M02. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antennas 512 (i.e., multiple antennas), including multiple antenna panels or antenna arrays, which may be capable of concurrently transmitting or receiving multiple wireless transmissions. The transceiver 508 may communicate bi-directionally using one or more receivers 515 and one or more transmitters 517, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the more than one antennas 512.

According to aspects of the present disclosure, the device 502 may be an NCR device 130 (FIGS. 1-3) for repeating wireless communication. The device 502 has at least one transceiver 508 that includes at least one receiver 515 and at least one transmitter 517 that enable the device 502 to communicate with a network entity or network device 102a and to a user device such as UE 104a (FIG. 1). In particular, the at least one transceiver 508 enables the device 502 to communicate: (i) with at least one network device 102a (FIG. 1) of a wireless communications system 100 (FIG. 1) via (a) a first link (e.g., control link 132 (FIGS. 1-3)) or (b) a second link (e.g., backhaul link 134 (FIGS. 1-3)); and (ii) with a user device (UE 104a (FIG. 1)) via a third link (e.g., access link 140 (FIGS. 1-3)). A controller 507 of the device 502 is communicatively coupled to the at least one transceiver 508. The controller 507 receives, via the at least one transceiver 508 from the at least one network device 102a (FIG. 1), one or more control messages that include a configuration for sending repeater capability information of the third link, such as access link 140 (FIGS. 1-3) . In response to receiving the configuration, the controller 507 determines the repeater capability information and transmits, via the at least one transceiver 508, the repeater capability information to the at least one network device 102a (FIG. 1).

In one or more embodiments, the controller 507 communicatively attaches, via the at least one transceiver 508 and the first link (140 (FIGS. 1-3)), a network-controlled repeater mobile terminal (NCR-MT) 136 (FIG. 2) to the network device 102a (FIG. 1). The controller 507 transmits, via the at least one transceiver 508, the repeater capability information in response to attaching the NCR-MT 136 (FIG. 2) to the network device 102a (FIG. 1).

In one or more embodiments, the configuration includes a predefined table of one or more fine details of each capability information. In one or more embodiments, the capability information includes one or more supported beams for the third link. In one or more particular embodiments, the controller 507 transmits the capability information in an information element (IE) defining beam parameters per band of the third link. In one or more specific embodiments, the controller 507 transmits the capability information in the IE, which further defines a maximum number of supported beams for each of downlink transmission and uplink reception of the third link per supported band. In one or more specific embodiments, the controller 507 transmits the capability information in the IE, which further defines a respective beam width of supported beams for each of downlink transmission and uplink reception of the third link per supported band. In one or more specific embodiments, the controller 507 transmits the capability information in the IE, which further defines one or more narrow beams supported within a corresponding wide beam for each of downlink transmission and uplink reception of the third link per supported band. In one or more specific embodiments, the controller 507 transmits the capability information in the IE, which further defines a number of supported antenna panels. In one or more specific embodiments, the controller 507 transmits the capability information in the IE, which further defines respective angles for each reported beam related to an antenna panel boresight. In one or more specific embodiments, the controller 507 transmits the capability information in the IE, which further defines a maximum allowed transmission power per beam for interference management. In one or more specific embodiments, the controller 507 transmits the capability information as an NCR-MT specific message containing the IE.

In one or more embodiments, the controller 507 receives, via the at least one transceiver 508 from the network device 102a (FIG. 1), a request for details for a specific capability information. The controller 507 transmits, via the at least one transceiver 508, the details for the specific capability information in response to the request. In one or more particular embodiments, the request is a radio resource control (RRC) dedicated message. In one or more particular embodiments, the request is sent in physical first layer (L1) as a field in a repeater downlink control information (DCI) that carries side control information. In one or more particular embodiments, the request is an index of a predefined table that stores detailed capability information. In one or more particular embodiments, in response to the request, the controller 507, via the one or more transceivers 508, transmits detailed capability information in uplink control information (UCI) over physical uplink control channel (PUCCH) or physical uplink shared channel (PUSCH).

According to aspects of the present disclosure, the device 502 may be a network device 102a (FIGS. 1-3) that configures an NCR device 130 (FIGS. 1-3) for repeating wireless communication. The device 502 has the at least one transceiver 508 that includes at least one receiver 515 and at least one transmitter 517 that enable the device 502 to communicate directly with NCR device 130 (FIGS. 1-3) and indirectly with a user device such as UE 104a (FIG. 1). In particular, the at least one transceiver 508 enables the device 502 to communicate: (i) with a repeater device (e.g., NCR device 130 (FIGS. 1-3)) via a (a) first link (e.g., control link 132 (FIG. 1)) and (b) a second link (e.g., backhaul link 134 (FIG. 1)); and (ii) indirectly with a user device via the second link to the repeater device that repeats communication via a third link (e.g., access link 140 (FIG. 1)) with the user device (e.g., UE 104a (FIG. 1)). A controller 507 of the device 502 is communicatively coupled to the at least one transceiver 508. The controller 507 transmits, via the at least one transceiver 508 to the repeater device (e.g., NCR device 130 (FIGS. 1-3)), one or more control messages comprising a configuration for sending repeater capability information of the third link, prompting the repeater device to determine the repeater capability information. The controller 507 receives, via the at least one transceiver 508, the repeater capability information from the repeater device.

In one or more embodiments, the controller 507 configures the repeater device to transmit the repeater capability information in response to attaching to the device 502. The controller 507 attaches, via the at least one transceiver 508 and the first link, to a network-controlled repeater mobile terminal (NCR-MT) 136 (FIG. 2). The controller 507 receives, via the at least one transceiver 508, the repeater capability information during attachment to the NCR-MT 136 (FIG. 2) to the device 502. In one or more embodiments, the configuration includes a predefined table of one or more fine details of each capability information. In one or more embodiments, the capability information includes one or more supported beams for the third link.

In one or more embodiments, the configuration prompts the repeater device to transmit the capability information in an information element (IE) defining beam parameters per band of the third link. In one or more particular embodiments, the configuration prompts the repeater device to transmit the capability information in the IE including a maximum number of supported beams for each of downlink transmission and uplink reception of the third link per supported band. In one or more particular embodiments, the configuration prompts the repeater device to transmit the capability information in the IE including a respective beam width of supported beams for each of downlink transmission and uplink reception of the third link per supported band. In one or more specific embodiments, the configuration prompts the repeater device to transmit the capability information in the IE including one or more narrow beams supported within a corresponding wide beam for each of downlink transmission and uplink reception of the third link per supported band.

In one or more particular embodiments, the configuration prompts the repeater device to transmit the capability information in the IE including a number of supported antenna panels. In one or more specific embodiments, the configuration prompts the repeater device to transmit the capability information in the IE including respective angles for each reported beam related to an antenna panel boresight. In one or more particular embodiments, the configuration prompts the repeater device to transmit the capability information in the IE including a maximum allowed transmission power per beam for interference management. In one or more particular embodiments, the configuration prompts the repeater device to transmit the capability information as an NCR-MT specific message containing the IE.

In one or more embodiments, the controller 507 transmits, via the at least one transceiver 508 to the user device (e.g., UE 104a (FIG. 1)), a request for details for a specific capability information. The controller 507 receives, via the at least one transceiver, the details for specific capability information in response to the request. In one or more particular embodiments, the request is a radio resource control (RRC) dedicated message. In one or more particular embodiments, the request is sent in physical first layer (L1) as a field in a repeater downlink control information (DCI) that carries side control information.

In one or more embodiments, the request is an index of a predefined table that stores the detailed capability information. In one or more embodiments, in response to the request, the controller 507 receives, via the one or more transceivers 508, the detailed capability information in uplink control information (UCI) over physical uplink control channel (PUCCH) or physical uplink shared channel (PUSCH).

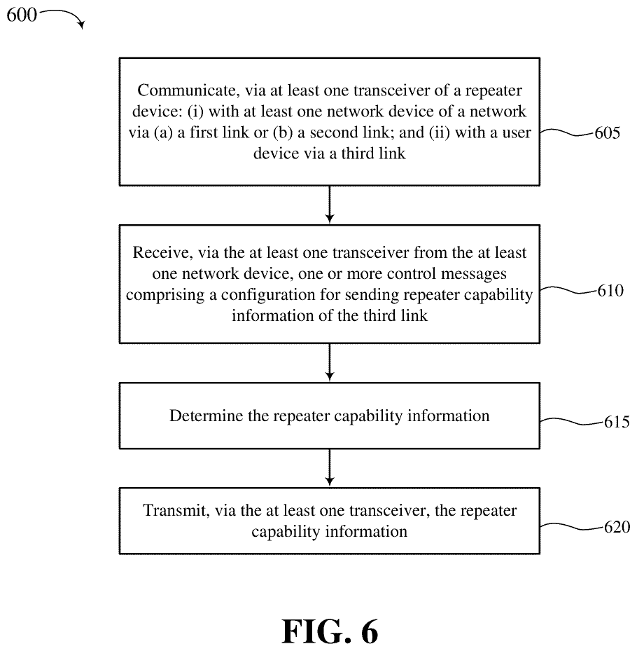

FIG. 6 illustrates a flowchart of a method 600 that efficiently extends wireless communication coverage using an NCR device that provides beam capability reports, in accordance with aspects of the present disclosure. The operations of the method 600 may be implemented by a device or its components as described herein. For example, the operations of the method 600 may be performed by a repeater device such as NCR device 130 (FIGS. 1-3) or device 502 (FIG. 5). In some implementations, the NCR device may execute a set of instructions to control the function elements of the network device to perform the described functions. Additionally, or alternatively, the NCR device may perform aspects of the described functions using special-purpose hardware.

At 605, the method 600 may include communicating, via at least one transceiver of a repeater device: (i) with at least one network device of a network via (a) a first link or (b) a second link; and (ii) with a user device via a third link. The operations of 605 may be performed in accordance with examples as described herein. In some implementations, aspects of the operations of 605 may be performed by a device as described with reference to FIGS. 1-3 and 5.

At 610, the method 600 may include receiving, via the at least one transceiver from the at least one network device, one or more control messages comprising a configuration for sending repeater capability information of the third link. The operations of 610 may be performed in accordance with examples as described herein. In some implementations, aspects of the operations of 610 may be performed by a device as described with reference to FIGS. 1-3 and 5.

At 615, the method 600 may include determining the repeater capability information in response to receiving the configuration. The operations of 615 may be performed in accordance with examples as described herein. In some implementations, aspects of the operations of 615 may be performed by a device as described with reference to FIGS. 1-3 and 5.

At 620, the method 600 may include transmitting, via the at least one transceiver, the repeater capability information to the network device. The operations of 620 may be performed in accordance with examples as described herein. In some implementations, aspects of the operations of 620 may be performed by a device as described with reference to FIGS. 1-3 and 5.

In one or more embodiments, the method 600 may further include communicatively attaching, via the at least one transceiver and the first link, a network-controlled repeater mobile terminal (NCR-MT) to the network device. The method 600 may further include transmitting, via the at least one transceiver, the repeater capability information in response to attaching the NCR-MT to the network device. In one or more embodiments, the configuration comprises a predefined table of one or more fine details of each capability information. In one or more embodiments, the capability information comprises one or more supported beams for the third link. In one or more particular embodiments, the method 600 includes transmitting the capability information in an information element (IE) defining beam parameters per band of the third link. In one or more specific embodiments, the method 600 includes transmitting the capability information in an IE including a maximum number of supported beams for each of downlink transmission and uplink reception of the third link per supported band.

In one or more specific embodiments, the method 600 includes transmitting the capability information in an IE including a respective beam width of supported beams for each of downlink transmission and uplink reception of the third link per supported band. In one or more specific embodiments, the method 600 includes transmitting the capability information in an IE including one or more narrow beams supported within a corresponding wide beam for each of downlink transmission and uplink reception of the third link per supported band. In one or more specific embodiments, the method 600 includes transmitting the capability information in the IE including a number of supported antenna panels. In one or more specific embodiments, the method 600 includes transmitting the capability information in the IE including respective angles for each reported beam related to an antenna panel boresight. In one or more specific embodiments, the method 600 includes transmitting the capability information in the IE including a maximum allowed transmission power per beam for interference management. In one or more specific embodiments, the method 600 includes transmitting the capability information as an NCR-MT specific message containing the IE.

In one or more embodiments, the method 600 includes receiving, via the at least one transceiver from the network device, a request for details for a specific capability information. The method 600 includes transmitting, via the at least one transceiver, the details for the specific capability information in response to the request. In one or more particular embodiments, the request is a radio resource control (RRC) dedicated message. In one or more particular embodiments, the method 600 includes receiving the request in physical first layer (L1) as a field in a repeater downlink control information (DCI) that carries side control information. In one or more particular embodiments, the request is an index of a predefined table that stores detailed capability information. In one or more particular embodiments, the method 600 includes transmitting detailed capability information in uplink control information (UCI) over physical uplink control channel (PUCCH) or physical uplink shared channel (PUSCH) in response to the request.

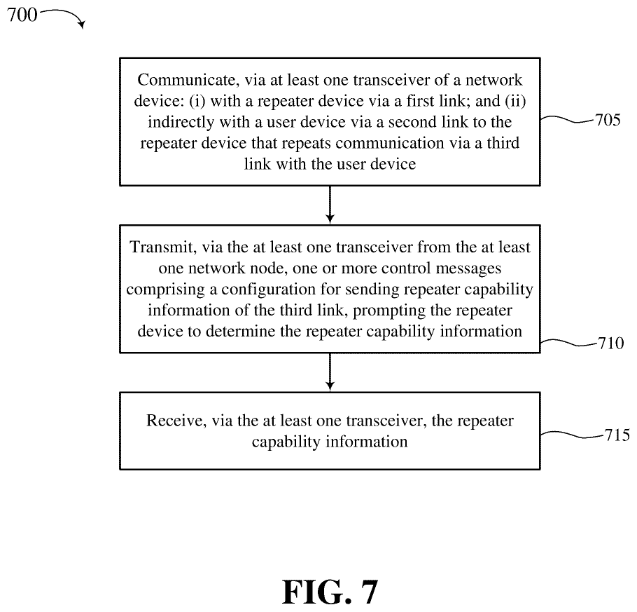

FIG. 7 illustrates a flowchart of a method 700 that efficiently extends wireless communication coverage using an NCR device that provides beam capability reports, in accordance with aspects of the present disclosure. The operations of the method 700 may be implemented by a device or its components as described herein. For example, the operations of the method 700 may be performed by a network device such as network device 130 (FIGS. 1-3) or device 502 (FIG. 5). In some implementations, the network device may execute a set of instructions to control the function elements of the network device to perform the described functions. Additionally, or alternatively, the user device may perform aspects of the described functions using special-purpose hardware.

At 705, the method 700 may include communicating, via at least one transceiver of a network device: (i) with a repeater device via a first link; and (ii) indirectly with a user device via a second link to the repeater device that repeats communication via a third link with the user device. The operations of 705 may be performed in accordance with examples as described herein. In some implementations, aspects of the operations of 705 may be performed by a device as described with reference to FIGS. 1-3 and 5.

At 710, the method 700 may include transmitting, via the at least one transceiver from the at least one network node, one or more control messages comprising a configuration for sending repeater capability information of the third link, the configuration prompting the repeater device to determine the repeater capability information. The operations of 710 may be performed in accordance with examples as described herein. In some implementations, aspects of the operations of 710 may be performed by a device as described with reference At 715, the method 700 may include receiving, via the at least one transceiver, the repeater capability information. The operations of 715 may be performed in accordance with examples as described herein. In some implementations, aspects of the operations of 715 may be performed by a device as described with reference to FIGS. 1-3 and 5.

In one or more embodiments, the method 700 may further include configuring the repeater device to transmit the repeater capability information in response to attaching to the network device. The method 700 may further include attaching, via the at least one transceiver and the first link, to a network-controlled repeater mobile terminal (NCR-MT) of the repeater device. The method 700 may further include receiving, via the at least one transceiver, the repeater capability information during attachment to the NCR-MT to the network device.

In one or more embodiments, the configuration includes a predefined table of one or more fine details of each capability information. In one or more embodiments, the capability information comprises one or more supported beams for the third link. In one or more embodiments, the configuration prompts the repeater device to transmit the capability information in an information element (IE) defining beam parameters per band of the third link. In one or more particular embodiments, the configuration prompts the repeater device to transmit the capability information in the IE including a maximum number of supported beams for each of downlink transmission and uplink reception of the third link per supported band. In one or more particular embodiments, the configuration prompts the repeater device to transmit the capability information in the IE including b a respective beam width of supported beams for each of downlink transmission and uplink reception of the third link per supported band. In one or more particular embodiments, the configuration prompts the repeater device to transmit the capability information in the IE including one or more narrow beams supported within a corresponding wide beam for each of downlink transmission and uplink reception of the third link per supported band. In one or more particular embodiments, the configuration prompts the repeater device to transmit the capability information in the IE including a number of supported antenna panels. In one or more specific embodiments, the configuration prompts the repeater device to transmit the capability information in the IE including a respective angles for each reported beam related to an antenna panel boresight.

In one or more embodiments, the configuration prompts the repeater device to transmit the capability information in the IE including a maximum allowed transmission power per beam for interference management. In one or more embodiments, the configuration prompts the repeater device to transmit the capability information as an NCR-MT specific message containing the IE.

In one or more embodiments, the method 700 may further include transmitting, via the at least one transceiver to the user device, a request for details for a specific capability information. The method 700 may further include receiving, via the at least one transceiver, the details for specific capability information in response to the request. In one or more particular embodiments, the request is a radio resource control (RRC) dedicated message. In one or more particular embodiments, the method 700 may further include transmitting the request in physical first layer (L1) as a field in a repeater downlink control information (DCI) that carries side control information.

In one or more particular embodiments, the request is an index of a predefined table that stores the detailed capability information. In one or more particular embodiments, the method 700 further includes receiving the detailed capability information in uplink control information (UCI) over physical uplink control channel (PUCCH) or physical uplink shared channel (PUSCH) in response to the request.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A repeater device for wireless communication, the repeater device comprising:
at least one memory; and
at least one processor communicatively coupled with the at least one memory and configured to cause the repeater device to:
receives, from at least one base station, one or more control messages comprising a configuration for sending repeater capability information of a third link with a user equipment (UE), the repeater device communicatively coupled with the at least one base station via a first link or a second link and with the UE via the third link; and
in response to receiving the configuration:
determine the repeater capability information; and
transmits the repeater capability information to the at least one base station.

2. The repeater device of claim 1, wherein the at least one processor is configured to cause the repeater device to:
communicatively attach, via the first link, a network-controlled repeater mobile terminal (NCR-MT) of the controller to the base station; and
transmits, the repeater capability information in response to attaching the NCR-MT to the base station.

3. The repeater device of claim 1, wherein:
the configuration comprises a predefined table of one or more details associated with each capability information; and
the capability information comprises one or more supported beams for the third link, and the at least one processor is configured to cause the repeater device to transmits the capability information in an information element (IE) comprising beam parameters per band of the third link.

4. The repeater device of claim 3, wherein the at least one processor is configured to cause the transmit the capability information in the IE comprising a maximum number of supported beams for downlink transmission and uplink reception of the third link per supported band.

5. The repeater device of claim 3, wherein the at least one controller processor is configured to cause the repeater device to transmit the capability information in the IE comprising a respective beam width of supported beams for downlink transmission and uplink reception of the third link per supported band.

6. The repeater device of claim 3, wherein the at least one processor is configured to cause the repeater device to transmit the capability information in the IE comprising one or more narrow beams supported within a corresponding wide beam for downlink transmission and uplink reception of the third link per supported band.

7. The repeater device of claim 3, wherein the at least one processor is configured to cause the repeater device to transmit the capability information in the IE comprising a number of supported antenna panels.

8. The repeater device of claim 7, wherein the at least one processor is configured to cause the repeater device to transmit the capability information in the IE comprising respective angles for each reported beam related to an antenna panel boresight.

9. The repeater device of claim 3, wherein the at least one processor is configured to cause the repeater device to transmit the capability information in the IE comprising a maximum allowed transmission power per beam for interference management.

10. The repeater device of claim 3, wherein the at least one processor is configured to cause the repeater device to transmit the capability information as a network-controlled repeater mobile terminal (NCR-MT) specific message containing the IE.

11. The repeater device of claim 1, wherein the at least one processor is configured to cause the repeater device to:
receive, from the base station, a request for details related to a specific capability information; and
transmit the details related to the specific capability information in response to the request.

12. The repeater device of claim 11, wherein the request is a radio resource control (RRC) dedicated message.

13. The repeater device of claim 11, wherein the request is sent in physical first layer (L1) as a field in a repeater downlink control information (DCI) that carries side control information.

14. The repeater device of claim 11, wherein the request is an index of a predefined table that stores detailed capability information.

15. The repeater device of claim 11, wherein, in response to the request, the at least one processor is configured to cause the repeater device to transmit detailed capability information in uplink control information (UCI) over physical uplink control channel (PUCCH) or physical uplink shared channel (PUSCH).

16. A method for wireless communication at a repeater device, the method comprising:
establishing a communication with: (i) at least one base station of a network via (a) a first link or (b) a second link; and (ii) a user equipment (UE) via a third link; and
receiving, from the at least one base station, one or more control messages comprising a configuration for sending repeater capability information of the third link;
in response to receiving the configuration:
determining the repeater capability information; and
transmitting the repeater capability information to the at least one base station;
wherein the configuration comprises a predefined table of one or more details associated with each capability information; and
wherein the capability information comprises one or more supported beams for the third link; and
transmitting the capability information in an information element (IE) defining beam parameters per band of the third link.

17. The method of claim 16, further comprising:
receiving, from the at least one base station, a request for details related to a specific capability information, wherein the request is at least one of a radio resource control (RRC) dedicated message and an index of a predefined table that stores detailed capability information and the request is received in physical first layer (L1) as a field in a repeater downlink control information (DCI) that carries side control information; and
transmitting the details related to the specific capability information in uplink control information (UCI) over physical uplink control channel (PUCCH) or physical uplink shared channel (PUSCH), in response to the request.

18. A base station for wireless communication, the base station comprising:
at least one memory; and
at least one processor communicatively coupled to the at least one memory and configured to cause the base station to:
transmits to a repeater device via a third link communicatively connecting the base station to the repeater device, one or more control messages comprising a configuration for sending repeater capability information of the third link, the one or more control messages prompting the repeater device to determine the repeater capability information; and
receives from the repeater device, the repeater capability information.

19. The base station of claim 18, wherein the at least one processor further configures the base station to:
configure the repeater device to transmit the repeater capability information in response to attaching to the base station;
attach, via a first link, to a network-controlled repeater mobile terminal (NCR-MT) of the repeater device; and
receives the repeater capability information during attachment of the NCR-MT to the base station.

20. The base station of claim 18, wherein:
the configuration comprises a predefined table of one or more details associated with each capability information; and
the capability information comprises one or more supported beams for the third link, and the configuration prompts the repeater device to transmit the capability information in an information element (IE) defining beam parameters per band of the third link.
